(19) United States
(12) Patent Application Publication
(10) Pub. No.: US 2006/0248243 A1
(43) Pub. Date: Nov. 2, 2006

(54) METHOD FOR STORAGE SPACE ALLOCATION AND DATA RECORDING ON A DVD RE-WRITABLE DISC

(76) Inventors: Kun-Chang Chang, Hsinchu (TW); Chih-Hsien Yang, Hsinchu (TW); Chien-Hung Wu, Hsinchu (TW); Yi-Chang Chang, Hsinchu (TW); Fu-Cheng Chen, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/306,812

(22) Filed: Jan. 12, 2006

(30) Foreign Application Priority Data
Mar. 16, 2005 (TW) 94107988

(51) Int. Cl. G06F 5/00; G06F 3/00

(52) U.S. Cl. 710/52

(57) ABSTRACT

A method for storage space allocation is disclosed. According to the present invention, the video data and the still picture data are recorded in a common storage area on a re-writable disc. When the still picture data is to be stored, it is recorded from the high-address end of the common storage area. On the other hand, when the video data is to be stored, it is recorded from the low-address end of the common area.

### CROSS-REFERENCE TO RELATED APPLICATION

This application claims the priority benefit of Taiwan application serial no. 94107988, filed on Mar. 16, 2005. All disclosure of the Taiwan application is incorporated herein by reference.

### BACKGROUND OF THE INVENTION

1. Field of the Invention

The present invention relates to a method for storage space allocation and data recording on a re-writable disc, and more particularly, to a method for storage space allocation and data recording on a DVD re-writable disc that is compatible with a DVD-Video specification for recording the video data and the still picture data.

2. Description of the Related Art

In order to record the video data (e.g. the video movie recorded in real-time) and the still picture data (e.g. the picture taken in real-time) and to be compatible with the DVD-Video specification, a method for storage space allocation shown in FIG. 1 is commonly used on a typical DVD re-writable disc.

In the DVD re-writable disc of FIG. 1, a Leadin (lead-in area) disposed before all data areas is used to store disc-related information for the DVD, such as the information of disc type and capacity of storage space. A video data file system area FSV is used to store metadata for recording a file system of the video data, i.e. the data for describing the file system structure, such as the information of size and position of each file. A video data area SV is used to store the video data. A still picture file system area FSP is used to store metadata for recording a file system of the still picture data. A still picture data area SP is used to store the still picture data. Finally, a Leadout (lead-out area) disposed after all data areas is used to define a range of user data on the DVD for avoiding the optical disc driver erroneously accessing the disc in the high-address area.

The video data in the video data area SV is recorded in an order of 1, 2, 3, and 4 as shown in FIG. 1, whereas the still picture data in the still picture data area SP is recorded in an order of A, B, C, and D as shown in FIG. 1; and both are recorded in the order from the lower address to the higher address. In addition, RV and RP are the reserved storage spaces within the video data area SV and the still picture data area SP for future recording of video data and still picture data, respectively.

FIG. 2 schematically shows a flow chart illustrating a method for recording data corresponding to the method for storage space allocation in FIG. 1. First in step 202, it is determined whether the DVD re-writable disc for recoding data is a blank disc or not. If it is not a blank disc, the process goes to step 206. If it is a blank disc, a storage space is allocated into a video data area SV and a still picture data area SP in step 204.

Then in step 206, it is determined which type of a data to be recorded. If it is a video data, in step 208 it is further determined whether the reserved storage space RV of the video data area SV is sufficient to record the data. If it is sufficient, the video data is recorded from the lowest address of the reserved storage space RV of the video data area SV in step 210, and the process is done.

On the other hand, if it is determined in step 206 that the data to be recorded is a still picture data, in step 212 it is further determined whether the reserved storage space RP of the still picture data area SP is sufficient to record the data. If it is sufficient, the still picture data is recorded from the lowest address of the reserved storage space RP of the still picture data area SP in step 214, and the process is done.

According to the conventional method mentioned above, the size of the video data area SV and the size of the still picture data area SP are fixedly allocated and cannot be changed after the first record of the data has been written. As a result, each of the reserved storage space can not be used by the other data type as the storage space allocation is inflexible. Especially for some applications such as recording video data in real-time, it is not predictable to decide an appropriate ratio to allocate storage spaces for these two data areas. Thus, the only way to allocate the storage spaces is probably using a ratio predetermined by trial-and-error. As a result, on a disc if one of the storage spaces is used up, the type of data corresponding to the exhausted data area cannot be recorded any more on this disc even there is still unused storage space in the other data area. Accordingly, this reduces the efficiency of disc storage space utilization and increases inconvenience.

### SUMMARY OF THE INVENTION

Therefore, it is an object of the present invention to provide a method for storage space allocation on a re-writable disc for resolving the inflexibility of conventional storage space allocation and improving the efficiency of storage space utilization on a re-writable disc.

In order to achieve the object mentioned above, the present invention provides a method for storage space allocation on a re-writable disc. According to the method, a common storage area used to store a video data or a still picture data on the re-writable disc is defined. When storing the video data, it is recorded from a low-address end of the common storage area. And when storing the still picture data, it is recorded from a high-address end of the common storage area.

In an embodiment, the re-writable disc further has a video data file system area. that is used to store a metadata for recording a file system of the video data. The video data file system area could be disposed at a portion with lower address than that of the common storage area. The re-writable disc may further have a lead-in area that is disposed at a portion with lower address than that of the common storage area and is used to store disc-related information of the re-writable disc, and the video data file system area is disposed between the lead-in area and the common storage area.

In an embodiment, the re-writable disc further has a still picture data file system area. that is used to store a metadata for recording a file system of the still picture data. The still picture data file system area could be disposed at a portion with higher address than that of the common storage area. The re-writable disc may further have a lead-out area that is disposed at a portion with higher address than that of the common storage area, and the still picture data file system area is disposed between the lead-out area and the common storage area.

In an embodiment, the re-writable disc comprises both a video data file system area and a still picture file system area. The video data file system area is disposed at a portion with lower address than that of the still picture file system area and stores the address of the still picture file system area. A file system with a tree structure could be utilized to record the video data and the still picture data.

According to another object, the present invention provides for recording data on a re-writable disc. According to the method, a data which could be is a video data or a still picture data received. And it is determined whether a reserved storage space of a common storage area in the re-writable disc is sufficient to record the data or not. If the reserved storage space of the common storage area is sufficient to record the data, the data will be recorded in the common storage area.

In an embodiment, if the data is the video data, the data could be recorded from a portion with the lowest address in the reserved storage space in the common storage area; if the data is the still picture data, the data could be recorded from a portion with the highest in the reserved storage space in the common storage area.

It is yet another object of the present invention to provide a re-writable disc. On the disc according to the present invention, it has a common storage area used to store a video data or a still picture data, a video data file system area used to store a metadata for recording a file system of the video data on the re-writable disc, and a still picture file system area used to store a metadata for recording a file system of the still picture data on the re-writable disc.

In an embodiment, the video data file system area is disposed at a portion with lower address than that of the still picture file system area. The video data file system area could further store the address of the still picture file system area. The re-writable disc can also has a lead-in area and a lead-out area. The lead-in area is disposed at a portion with lower address than that of the common storage area and is used to store disc-related information of the re-writable disc, and the lead-out area is disposed at a portion with higher address than that of the common storage area. In an embodiment, the video data file system area is disposed between the lead-in area and the common storage area, and the still picture file system area is disposed between the lead-out area and the common storage area.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 schematically shows a method for storage space allocation on a DVD re-writable disc in the prior art.

FIG. 2 schematically shows a flow chart illustrating a method for recording data on a DVD re-writable disc in the prior art.

FIG. 3 schematically shows a method for storage space allocation on a DVD re-writable disc according to an embodiment of the present invention.

FIG. 4 schematically shows a flow chart illustrating a method for recording data on a DVD re-writable disc according to an embodiment of the present invention.

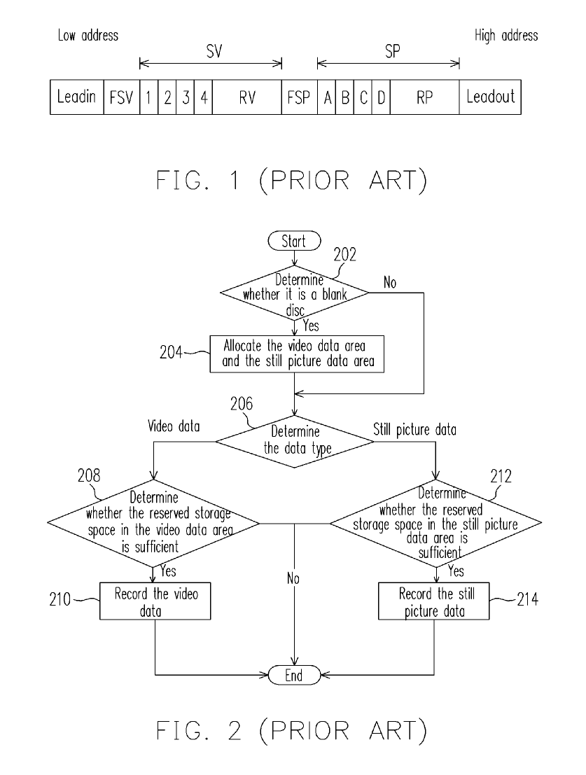

### DESCRIPTION OF THE PREFERRED EMBODIMENTS

FIG. 3 schematically shows a method for storage space allocation on a DVD re-writable disc according to an embodiment of the present invention. As shown in FIG. 3, a Leadin (lead-in area), a video data file system area FSV, a common storage area SC, a still picture file system area FSP, and a Leadout (lead-out area) are sequentially disposed from low-address end to the high-address end in a DVD re-writable disc. In the present embodiment, the low-address end is located on the inner side of the disc, and the high-address end is located on the outer side of the disc.

The video data file system area FSV and the still picture file system area FSP are used to store the metadata for recording the file systems of the video data and the still picture data, respectively. In the present embodiment, both the video data and the still picture data are recorded in a file system with a tree structure. Here, the file system with a tree structure is configured as at least one file or sub-directory on a root directory, and each sub-directory may contain one or more files or other lower layer sub-directories just like the expending branches of a tree. Therefore, the metadata stored in the video data file system area FSV and the still picture file system area FSP depict the relationship between each directory and file, the size of each directory and file, and the address of each directory and file on the DVD re-writable disc.

In the present embodiment, both the video data and the still picture data are stored in the common storage area SC. The video data is recorded from the low-address end to the high-address end of the common storage area SC as in the order of 1, 2, 3, and 4 as shown in FIG. 3. On the other hand, the still picture data is recorded from the high-address end to the low-address end of the common area SC as in the order of A, B, C, and D as shown in FIG. 3. Thus, both the video data and the still picture data can share the common storage area SC, and the reserved storage spaces for both data types can be managed as a whole. Accordingly, the present invention can improve the flexibility of storage space utilization.

The video data of the present embodiment is recorded from the lower address of the DVD re-writable disc, such that the video data can be read by a general DVD player. Since the address of the still picture file system area FSP is stored in the video data file system area FSV, the still picture data can be accurately accessed by the apparatus supporting the DVD re-writable disc. Therefore, the present invention not only improves the flexibility of storage space utilization, but also maintains the compatibility with the DVD-Video specification.

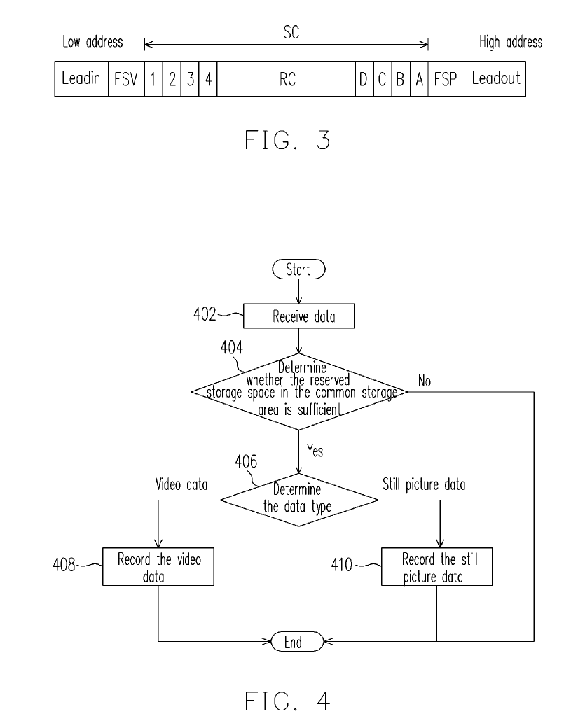

FIG. 4 schematically shows a flow chart illustrating a method for recording data on a DVD re-writable disc according to an embodiment of the present invention corresponding to the storage space allocation illustrated in FIG. 3. First in step 402, a record of data is received that could be either a video data or a still picture data. Then in step 404, it is determined whether the reserved storage space RC of the common storage area SC on the DVD re-writable disc is sufficient to record data. If the reserved storage space RC is insufficient, the process is ended. If the reserved storage area RC is sufficient, the process goes to step 406.

Then in step 406, it is determined which type of the data to be recorded. If it is a video data, the data is recorded from the portion with the lowest address in the reserved storage space RC of the common area SC in step 408. On the other hand, if it is a still picture data, the data is recorded from the portion with the highest address in the reserved storage space RC of the common area SC in step 410.

In summary, the present invention records both the video data and the still picture data in a common storage area. According to the embodiment of the present invention, the video data is recorded from the low-address end to the high-address end of the common storage area, and the still picture data is recorded from the high-address end to the low-address end of the common storage area. Both data share the same reserved storage space of the whole disc. Accordingly, the whole storage space of the disc is fully utilized by the video data and the still picture data. In addition, the present invention is compatible with the DVD-Video specification and improves the flexibility of storage space utilization.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A method for storage space allocation on a re-writable disc, comprising:
defining a common storage area on the re-writable disc, wherein the common storage area is used to store a video data or a still picture data;
when storing the video data, recoding the video data from a low-address end of the common storage area; and
when storing the still picture data, recoding the still picture data from a high-address end of the common storage area.

2. The method for storage space allocation on the re-writable disc of claim 1, wherein the re-writable disc further comprises a video data file system area that is used to store a metadata for recording a file system of the video data on the re-writable disc.

3. The method for storage space allocation on the re-writable disc of claim 2, wherein the video data file system area is disposed at a portion with lower address than that of the common storage area.

4. The method for storage space allocation on the re-writable disc of claim 3, wherein the re-writable disc further comprises a lead-in area that is disposed at a portion with lower address than that of the common storage area and is used to store disc-related information of the re-writable disc, and the video data file system area is disposed between the lead-in area and the common storage area.

5. The method for storage space allocation on the re-writable disc of claim 1, wherein the re-writable disc further comprises a still picture file system area that is used to store a metadata for recording a file system of the still picture data on the re-writable disc.

6. The method for storage space allocation on the re-writable disc of claim 5, wherein the still picture file system area is disposed at a portion with higher address than that of the common storage area.

7. The method for storage space allocation on the re-writable disc of claim 6, wherein the re-writable disc further comprises a lead-out area that is disposed at a portion with higher address than that of the common storage area, and the still picture file system area is disposed between the lead-out area and the common storage area.

8. The method for storage space allocation on the re-writable disc of claim 1, wherein the re-writable disc further comprises a video data file system area and a still picture file system area; the video data file system area is used to store a metadata for recording a file system of the video data on the re-writable disc, and the still picture file system area is used to store a metadata for recording a file system of the still picture data on the re-writable disc.

9. The method for storage space allocation on the re-writable disc of claim 8, wherein the video data file system area is disposed at a portion with lower address than that of the still picture file system area.

10. The method for storage space allocation on the re-writable disc of claim 9, wherein the video data file system area stores the address of the still picture file system area.

11. The method for storage space allocation on the re-writable disc of claim 1, wherein a file system with a tree structure is utilized to record the video data and the still picture data.

12. A method for recording data on a re-writable disc, comprising:
receiving a data, wherein the data is a video data or a still picture data;
determining whether a reserved storage space of a common storage area in the re-writable disc is sufficient to record the data or not; and
if the reserved storage space of the common storage area is sufficient to record the data, recording the data in the common storage area.

13. The method for recording data on the re-writable disc of claim 12, wherein the step of recording the data further comprises:
if the data is the video data, recording the data from a portion with the lowest address in the reserved storage space in the common storage area; and
if the data is the still picture data, recording the data from a portion with the highest in the reserved storage space in the common storage area.

14. A re-writable disc, comprising:
a common storage area used to store a video data or a still picture data;
a video data file system area used to store a metadata for recording a file system of the video data on the re-writable disc; and
a still picture file system area used to store a metadata for recording a file system of the still picture data on the re-writable disc.

15. The re-writable disc of claim 14, wherein the video data file system area is disposed at a portion with lower address than that of the still picture file system area.

16. The re-writable disc of claim 14, wherein the video data file system area stores the address of the still picture file system area.

17. The re-writable disc of claim 14, wherein the re-writable disc further comprising:
a lead-in area that is disposed at a portion with lower address than that of the common storage area and is used to store disc-related information of the re-writable disc; and
a lead-out area that is disposed at a portion with higher address than that of the common storage area.

18. The re-writable disc of claim 17, wherein the video data file system area is disposed between the lead-in area and the common storage area, and the still picture file system area is disposed between the lead-out area and the common storage area.
